(19) United States
(12) Patent Application Publication
(10) Pub. No.: US 2011/0057776 A1
(43) Pub. Date: Mar. 10, 2011

(54) Process Of Controlling The Correct Connection Of At Least One Power Driven User To Various Power Outlets

(76) Inventor: Stéphane Biziorek, Champlitte (FR)

(21) Appl. No.: 12/991,021

(22) PCT Filed: Apr. 29, 2009
(86) PCT No.: PCT/EP2009/055199

§ 371 Date: Nov. 4, 2010

(30) Foreign Application Priority Data
May 6, 2008 (EP) 08155729.0

(51) Int. Cl. G06K 7/01; B60L 1/00

(52) U.S. Cl. 340/10.1; 307/9.1

(57) ABSTRACT

A system and method is provided for controlling the correct connection of power driven users, such as on an implement, to various power outlets on a tractor. Each user on the implement is identified by a signal coming from a sensor and being unique for this user. A controller generates a signal which is indicative of the activated and intended user, such as a user for raising a pick-up. In a verification phase these signals are assigned to each other, which assignment is stored in a memory valid until the users are separated from the outlets.

### FIELD OF THE INVENTION

The present disclosure relates to a system and method for controlling the connection of power driven users to various power outlets.

### BACKGROUND OF THE INVENTION

DE 10 2005 049 550 A1 discloses a hydraulic system of a work vehicle, such as an industrial machine, wherein a tool, such as a shovel, can be connected to an arm or the like. The tool comprises a tool recognition device which produces a recognition signal indicating the type of the tool connected to the work vehicle. As a consequence, the hydraulic circuit acts according to the characteristics of the tool.

US 2006/0131040 A1 shows a configurable hydraulic system for an agricultural tractor and implement combination. A controller optimizes the number of outlets on selective control valves with respect to the number and kind of connections required by single or double acting hydraulic actuators, which vary from implement to implement. It is desired to reduce the risk of a misconnection in case several users can be connected to several power outlets.

### SUMMARY

According to an aspect of the present disclosure, it does not harm, if a remote user is connected to the wrong power outlet for hydraulic, pneumatic or electric power, since the controller assures, that power is routed to the correct outlet. Insofar the system is self-teaching each time, when users are connected to it. The signal may be transmitted by wire or wireless and may be created by the user itself or by an emitter connected to the power line assigned to the user. The power source may be a single power source, like a pump, with several outlets or it may be several power sources each having one or more outlets. The user may be an electrical, hydraulic or pneumatic motor moving a component on a machine, like a shift lever, a tying system, a bale gate, a tool on a loader, a wrapping table, etc.

Using an emitter on the power line, its coupler or the like is a fast and simple way to tell the controller, which user is connected to a specific outlet. The emitter may send an electro magnetic or acoustic signal to a receiver close to the outlet. But the emitter could be a bar code as well, which is scanned by a scanner at the outlet. In addition a signal may be emitted by mechanical pins, or the like, which due to their size, combination of several pins, shape, etc. are able to tell a sensor or receiver which user they are assigned to. Preferably the signal is fed via a CAN or ISO bus from an implement, like a baler, mower, planter, loader, etc. to a tractor. Depending on the circumstances the emitter could also be located on the outlet side and the sensor could be on the user side.

Another way to create a signal is activating outlets and watching, which of the users is reacting. Sensors may be used in a power line, which would recognize flow of power. Sensors may be used as well on the user itself, like potentiometers, reed sensors, load sensors, etc. A process based on test movements of a remote user may also be used to find out, whether all users are working properly.

The controller may also have a memory for data about the operation of the respective user, like speed, dampening, pressure, etc. This will not only provide a b/w recognition of the respective user, but also user intelligence. Such additional operation data may also avoid conflicts, in case several users are activated simultaneously.

In order to run a self-teaching process for supplying power to the correct user an arrangement of coupling parts is provided, in which one is connected to a powered user and at least two are connected to several power outlets of a power source, whereas the part connected to the user contains an emitter for a signal representative for the user, received and used by a controller for the at least two power outlets of the power source. The emitter and the receiver may be of different types, like coded mechanic pins, acoustic or visible signals, electro magnetic or ultrasonic signals.

It is proven technique to use RFID tags, bar codes, wave sensors or the like and that a reader or sensor is provided in the arrangement such, that it can read the RFID tag, etc. once the coupling parts are connected to each other. Such signal providers are simple, cheap and do not require any movement of components by the user. They recognize the kind of the user even before the user would be operated. Such tags, bar codes, etc. could be attached to the exterior of the power line as well as integrated in it, which may provide protection against mechanical stress.

While in general it would be possible to provide for a mechanical or electrical assignment of the outlets to the users, an electronic and programmable computer provides more flexibility and may even be able to change the assignment during operation to apply different power supply characteristics, like pressure, flow rate, timing, etc.

### BRIEF DESCRIPTION OF THE DRAWINGS

FIG. 1 is a schematic side view of a tractor and an implement according to a first embodiment of the invention:

FIG. 2 is a schematic side view of a tractor and an implement according to a second embodiment of the invention; and

FIG. 3 is a logic flow diagram of a diagnostic algorithm performed by the controller of FIG. 1.

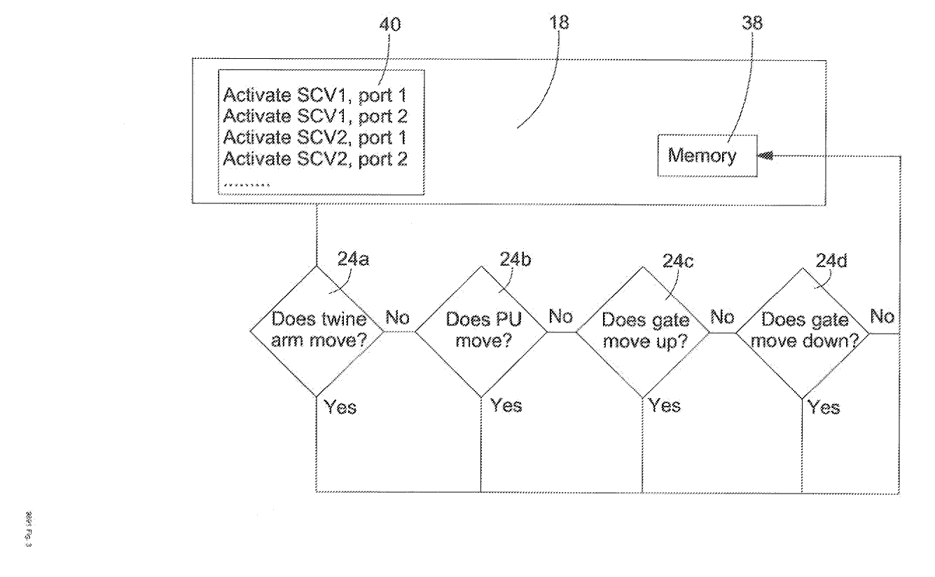

### DETAILED DESCRIPTION OF THE DRAWINGS

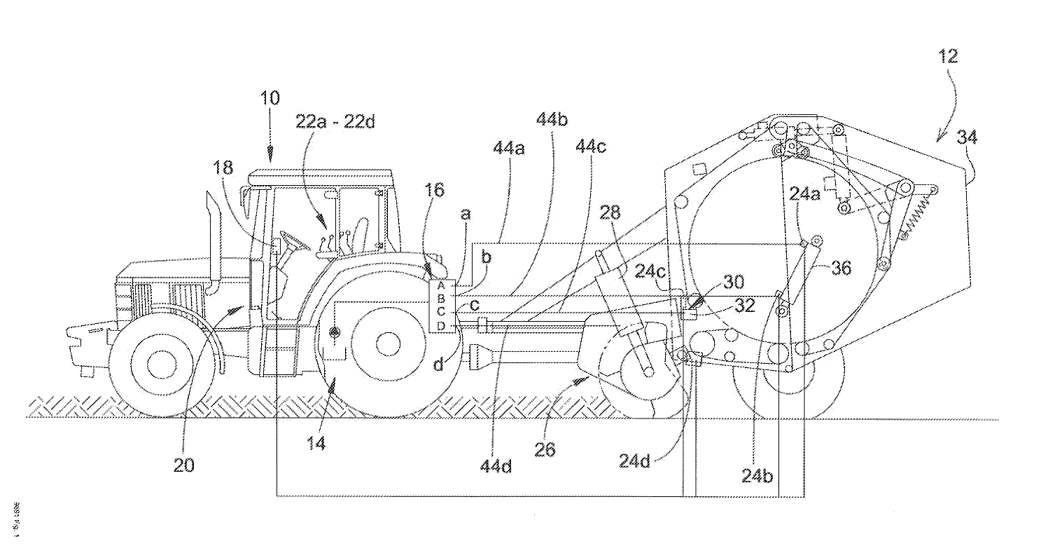

FIG. 1 shows a tractor 10 and an implement 12 being operated by the tractor 10. Instead of a tractor 10, any other kind of prime mover, like a truck, industrial machine, forestry machine, car, crane, etc. could be used. While the implement 12 is shown as an agricultural baler it also can be of any kind of implement hitched to the tractor 10 or attached or coupled to it or at least being operated by it. For example, it could be a front or read end loader, a seeder or planter, a sprayer, a mower, a forage harvester, a cultivator, a trailer, a wrapper, etc. etc.

The tractor 10 is provided with a power source 14, preferably supplying hydraulic power, outlets A, B, C, D, a power outlet controller 16 and a processor 18. The power source 14 as usual contains a pump, valves, lines, sump etc., which are useful to deliver e.g. pressurized oil to the outlets A-D. The outlets A-D usually are sockets into which plugs a, b, c, d at the end of hydraulic, pneumatic or electric power lines 44a, 44b, 44c, 44d can be inserted. Such outlets A-D may be provided as a bloc or individually. Such outlets are commonly referred to as the ports of selective control valves on tractors. While at least one outlet A-D is necessary, more than four outlets could be used as well. Allowing or avoiding flow of power through these power outlets A-D happens in the power outlet controller 16.

The power outlet controller 16 contains spools, electromagnets, etc. as is known in the art. It has a single inlet from and outlet to the power source 14 and the outlets A-D, which all are identical and thus allow the insertion of any of the plugs a-d. The power outlet controller 16 receives signals from the processor 18, such that this specific outlet out of A-D is activated, which is connected to the user, to be operated by a given controller 22a-2d on an operator station 20 of the tractor 10. Said controller 22a-22d can be substantially of any type, like a lever, a switch, a touch screen, a key board or the like. A control signal could also be generated automatically by another part of this processor 18 or by another controller on the tractor 10 or on the implement and fed by a BUS system from the implement 12.

Accordingly, it will depend on the signals received by the power outlet controller 16 from the processor 18 to which outlet A-D power will be directed, rather than by a direct connecting between a controller 22a, 22b, 22c, 22d on the operator station 20 and an outlet A-D.

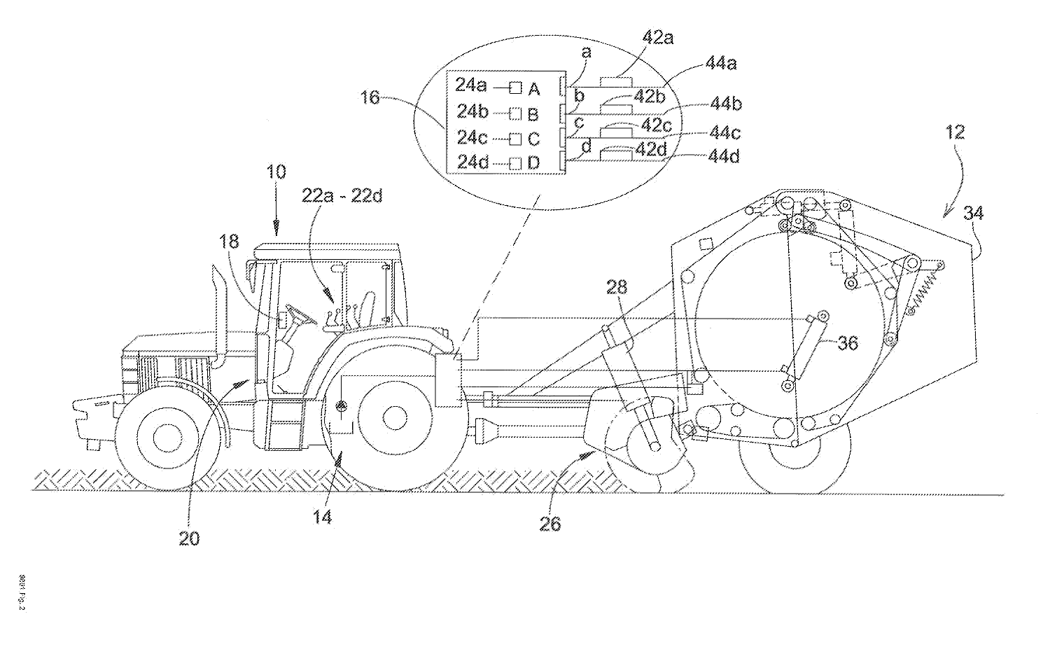

The processor 18 is located preferably on the operator's station 20 and is connected among others to the controllers 22a-22d, to the power source controller 16 and to sensors 24a, 24b, 24c, 24d, which according to the embodiment in FIG. 1 are located on the implement 12 and in the embodiment of FIG. 2, they are located close to the outlets A-D. Each of the sensors 24a-24d is assigned to a component on the implement, like a pick-up 26 raised by single acting hydraulic user 28, a twine dispenser 30 moved by a single acting hydraulic user 32, and a gate 34 raised and lowered by a double acting hydraulic user 36. All users 28, 32, 36 are formed as linear hydraulic motors or cylinders in this embodiment, but could be of another type as well. The sensors 24a-24d may be connected to the users 28, 32, 36 as such as well as to the components moved by the users 28, 32, 36. In one case they may detect a pressure, or the like, in another case a movement. In the processor 18 a memory 38 and for the embodiment of FIG. 1 a routine 40 is provided. It is one of the purposes of the processor 18 to receive an input signal from the actuation of one of the controllers 22 and to generate a signal corresponding to the input signal, which is useful to operate the respective user 28, 32, 36. For example, if a controller 22 is moved in order to raise the gate 34, the user 36 needs to extend, which will be accomplished by powering the respective power line 44b through activating the correct outlet A-D. The same would happen if a non shown sensor detects that a bale is produced and tied in the implement 12 and is ready to be ejected, caused by an automatic routine.

In the embodiment of FIG. 2 each power line 44a-44d is provided with an emitter 42a, 42b, 42c, 42d, which contains and sends out data identifying the user 28, 32, 36 respectively the related component. For example emitter 42a indicates, that it is connected to the rod end of user 36, which will be powered in order to raise the gate 34. While in this embodiment the emitter 42a is an RFID tag, it could also be of any other kind, like a bar code, acoustic or optical waves, mechanical pins with a certain pattern, etc.

The memory 38 collects information received from sensors 24a-24d, which indicate, which user 28, 32, 36 is connected to which of the outlets A-D until the plugs a-d are disconnected therefrom. In addition to the correct user assignments the memory 38 may also contain information helpful for the operation of the implement 12, like the gate 34 shall not be raised, when the twine dispenser 30 is activated. The memory 38 may also contain data about the operation of the respective user 28, 32, 36, like stroke speed and pressure of motor 32, moving the twine dispenser 30.

The routine 40 is applied only in the case of the embodiment of FIG. 1 and it determines which of the users 28, 32, 36 is connected to which outlet A-D. The design of the routine 40 is such, that all controllers 22a-22d are activated in series and after activation of one controller 22a-22d sensors 24a-24d are observed for emitting a signal indicating, which user 28, 32, 36 has been moved, and, where applicable, in which direction. Once all users 28, 32, 36 are assigned to all controllers 22a-22d respective information is stored in the memory 38 and operation of the implement 12 may be started. Once a user 28, 32, 36 is identified and assigned to one of the outlets A-D, it may be skipped, when the routine is performed with the next outlet A-D.

While in this embodiment also the sensors 24a-24d are asked for a signal in series, it would also be possible to use sensors 24a-24d emitting a signal, which is not ON-OFF only, but identifies also the user 28, 32, 36; in such a case all sensors 24a-24d could be checked in parallel.

The conversion of the above flow chart into a standard language for implementing the algorithm described by the flow chart in a digital computer or microprocessor, will be evident to one with ordinary skill in the art.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

1-7. (canceled)

8. A method for controlling the connection of at least one power driven user to various power outlets, the method comprising:
emitting a signal indicative of the user to a processor, the processor activating a correct power outlet accordingly.

9. The method of claim 8, wherein:
the signal is created by an emitter attached to a power line which connects the user to the power outlet.

10. The method of claim 9, wherein:
the signal is created in response to a test movement of the user.

11. The method of claim 8, wherein:
operation parameters for the user identified by the signal are taken from a memory in order to control a function of the user.

12. A system for coupling at least two power driven users to several power outlets of a power source, the system comprising:
an emitter associated with each user, each emitter generating a signal representative of the user; and
a processor which receives the signal and controls the at least two power outlets of the power source accordingly.

13. The system of claim 12, wherein:
the emitter is an RFID tag; and
a sensor reads the RFID tag when the user is connected to an outlet.

14. The system of claim 12, wherein:
the emitter is a bar code; and
a sensor reads the bar code when the user is connected to an outlet

15. The system of claim 12, wherein:
a processor activates the user in response to a control device assigned to a function of the user, irrespective of a chosen connection of the user to one of the power outlets.
